(19) United States
(12) Patent Application Publication
(10) Pub. No.: US 2009/0046947 A1
(43) Pub. Date: Feb. 19, 2009

(54) IMAGE PROCESSING APPARATUS AND IMAGE PROCESSING METHOD

(75) Inventor: Masanobu KOBAYASHI, Shiojiri (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 12/185,840

(22) Filed: Aug. 5, 2008

(30) Foreign Application Priority Data
Aug. 15, 2007 (JP) 2007-211655

(51) Int. Cl. G06K 9/36

(52) U.S. Cl. 382/284

(57) ABSTRACT

An image processing apparatus that generates a combined image by combining plural image data acquired as a result of digitizing plural images acquired by shooting with different quantities of exposure, includes a weighting unit that adds weight to adjust proportion of combination of the image data, to at least one of the plural image data. The weighting unit includes a luminance data generating unit that combines data related to luminance of the plural image data and thus generates combined luminance data, and a weight deciding unit that decides the weight added to the image data in accordance with the combined luminance data generated by the luminance data generating unit.

The entire disclosure of Japanese Patent Application No. 2007-211655, filed Aug. 15, 2007 is expressly incorporated by reference herein.

### BACKGROUND

1. Technical Field

The present invention relates to an image processing apparatus and an image processing method.

2. Related Art

The exposure time in shooting an image is an important element that decides the quality of the shot image. If an image is shot where an inappropriate exposure time is set, the shooting subject on the image may be blackened and cannot be recognized even though the subject can be visually recognized with human eyes. Meanwhile, there may be a case where reflected light is picked up as white on the image, causing so-called whiteout. In some cases, the shooting subject cannot be recognized because of derivation from whiteout.

As a traditional technique to solve such problems, JP-A-63-306777 discloses an HDR (high dynamic range) technique of slicing out images of proper brightness of plural images having different quantities of exposure and then combining these images to form a single image. Picking up images having different quantities of exposure can be easily realized by picking up an image by exposure for an ordinary exposure time (ordinary exposure) and then picking up an image by exposure for a shorter time than the ordinary exposure time (short-time exposure) and by exposure for a longer time (long-time exposure).

In combining images, luminance signals of images are normalized in accordance with the exposure time and therefore noise of the image of short-time exposure largely influences a particularly dark part of the combined image. Such inconvenience can be solved by weighting images so that an image shot by long-time exposure is mainly used for the dark part.

As a traditional technique of weighting and combining images, for example, JP-A-11-317905 may be employed. According to the invention described in JP-A-11-317905, an image picked up by ordinary exposure (ordinary exposure image) an image picked up by short-time exposure (short-time exposure image) and an image picked up by long-time exposure (long-time exposure image) are weighted in accordance with the intensity of luminance signals of the image picked up by ordinary exposure.

FIG. 10A to FIG. 10D are diagrams for explaining the traditional technique described in JP-A-11-317905. FIG. 10A and FIG. 10C are graphs in which the vertical axis represents a luminance signal outputted from a camera of an image pickup device and the horizontal axis represents luminance of a subject shot by ordinary exposure. FIG. 10B and FIG. 10D are graphs in which the vertical axis represents weight added when an ordinary exposure image, a short-time exposure image and a long-time exposure image are combined, and the horizontal axis represents luminance of a shot subject. In the graphs, the weight of the ordinary exposure image is indicated by a solid line, the weight of the long-time exposure image is indicated by a broken line, and the weight of the short-time exposure image is indicated by a double chain-dotted line.

In the case where the ordinary exposure image has an output characteristic as shown in FIG. 10A, the ordinary exposure image, the short-time exposure image and the long-time exposure image are weighted as shown in FIG. 10B and then combined. It can be seen from FIG. 10B that a low-luminance part of the combined image is strongly influenced by the long-time exposure image, an intermediate-luminance part is strongly influenced by the ordinary exposure image, and a high-luminance part is strongly influenced by the short-time exposure image.

According to the traditional technique described in JP-A-11-317905, noise of the short-time exposure image can be prevented from expanding and hence influencing the low-luminance part of the combined image.

However, blackening and whiteout may occur also in the ordinary exposure image. The ordinary exposure image is not always suitable as a reference of weighting. That is, the ordinary exposure image may have an output characteristic as shown in FIG. 10C. With the output characteristic shown in FIG. 10C, blackening has occurred in a low-luminance area of the ordinary exposure image and whiteout has occurred in a high-luminance area. If weighting is decided with reference to such an ordinary exposure image, the weight has a constant value irrespective of the luminance of the low-luminance and high-luminance areas of the image as shown in FIG. 10D.

Moreover, if the ordinary exposure image shown in FIG. 10C is combined as it is with the short-time exposure image and the long-time exposure image, the blackening and whiteout are combined as well and therefore the output characteristic of the combined image (the luminance of the combined image compared to the luminance level of the input signal) becomes non-linear. When the output characteristic is non-linear, linearity of the output characteristic of the combined image is broken and a pseudo-contour or the like is generated. This may lower the image quality of the combined image.

### SUMMARY

An advantage of some aspects of the invention is to provide an image processing apparatus and an image processing method in which each of plural images is properly weighted and then combined, thereby restraining noise in a dark part of the combined image, maintaining linearity of luminance, preventing generation of a pseudo-contour, and thus generating a high-quality image.

An image processing apparatus according to an aspect of the invention is an image processing apparatus that generates a combined image by combining plural image data acquired as a result of digitizing plural images acquired by shooting with different quantities of exposure. The apparatus includes a weighting unit that adds weight to adjust proportion of combination of the image data, to at least one of the plural image data. The weighting unit has a luminance data generating unit that combines data related to luminance of the plural image data and thus generates combined luminance data, and a weight deciding unit that decides the weight added to the image data in accordance with the combined luminance data generated by the luminance data generating unit.

In this image processing apparatus, the weight of image data can be decided in accordance with combined luminance data formed as a result of combining data related to luminance of plural image data acquired by shooting with different quantities of exposure. The combined luminance data has a broader linearity range of luminance signal level than the luminance of an image exposed for an ordinary exposure time. Therefore, proper weighting can be carried out within a broader luminance range than in the case where an image shot with an ordinary exposure time, of images having different exposure times, is used as a reference. Also, generation of a pseudo-contour can be restrained and deterioration in image quality can be prevented. Moreover, the proportion of a long-time exposure image in the combined image can be restrained and a combined image with high image quality and with less noise can be provided.

Thus, in the image processing apparatus, as each of plural images is properly weighted, noise in a dark part of the combined image can be restrained and linearity of luminance can be maintained. Moreover, generation of a pseudo-contour can be prevented and a high-quality image can be generated.

It is preferable that the image processing apparatus further includes a normalizing unit that normalizes the plural image data and equalizes brightness of each image data.

In this image processing apparatus, the difference in brightness due to the difference in quantity of exposure of plural image data is unified. Therefore, in preparing a combined image, normalized image data can be directly weighted. The combined image preparation processing can be simplified.

It is also preferable that the image processing apparatus has a linearizing unit that linearizes the combined image data, which is image data acquired as a result of adding the weight decided by the weight deciding unit to the plural image data and then combining the plural image data, with respect to the luminance of a subject.

In this image processing apparatus, the luminance of combined image data can be linearized. Therefore, a combined image with a uniform change in luminance and with high image quality can be provided.

It is also preferable that, in the image processing apparatus, the weight deciding unit decides weight by using a reference table or a function that associates image data and weight in accordance with luminance, and the normalizing unit normalizes the plural image data by using the reference table or the function.

In this image processing apparatus, the reference table or the function can be used to normalize image data as well as to decide weight. Therefore, it is not necessary to prepare a separate function or processing for normalization and the configuration of the apparatus can be simplified.

It is also preferable that, in the image processing apparatus, the weight deciding unit decides weight by using a reference table or a function that associates image data and weight, and the linearizing unit linearizes the combined image data by using the reference table or the function.

In this image processing apparatus, the reference table or the function can be used to linearize combined image data as well as to decide weight. Therefore, it is not necessary to prepare a separate function or processing for linearization and the configuration of the apparatus can be simplified.

An image processing method according to still another aspect of the invention is an image processing method executed in an image processing apparatus that generates a combined image by combining plural image data acquired as a result of digitizing plural images acquired by shooting with different quantities of exposure. The method includes adding weight to adjust proportion of combination of the image data, to at least one of the plural image data. This weighting includes combining data related to luminance of the plural image data and thus generating combined luminance data, and deciding the weight added to the image data in accordance with the generated combined luminance data.

In this image processing method, the weight of image data can be decided in accordance with combined luminance data formed as a result of combining data related to luminance of plural image data acquired by shooting with different quantities of exposure. The combined luminance data has a broader linearity range of luminance signal level than the luminance of an image exposed for an ordinary exposure time. Therefore, proper weighting can be carried out within a broader luminance range than in the case where an image shot with an ordinary exposure time, of images having different exposure times, is used as a reference. Also, generation of a pseudo-contour can be restrained and deterioration in image quality can be prevented. Moreover, the proportion of a long-time exposure image in the combined image can be restrained and a combined image with high image quality and with less noise can be provided.

Thus, in the image processing method, as each of plural images is properly weighted, noise in a dark part of the combined image can be restrained and linearity of luminance can be maintained. Moreover, generation of a pseudo-contour can be prevented and a high-quality image can be generated.

An image processing program according to still another aspect of the invention is an image processing program for causing a computer to realize image processing in which a combined image is generated by combining plural image data acquired as a result of digitizing plural images acquired by shooting with different quantities of exposure. The program includes a weighting function to add weight to adjust proportion of combination of the image data, to at least one of the plural image data. The weighting function includes a luminance data generating function to combine data related to luminance of the plural image data and thus generate combined luminance data, and a weight deciding function to decide the weight added to the image data in accordance with the combined luminance data generated by the luminance data generating function.

As this image processing program is executed by a computer, the weight of image data can be decided in accordance with combined luminance data formed as a result of combining data related to luminance of plural image data acquired by shooting with different quantities of exposure. The combined luminance data has a broader linearity range of luminance signal level than the luminance of an image exposed for an ordinary exposure time. Therefore, proper weighting can be carried out within a broader luminance range than in the case where an image shot with an ordinary exposure time, of images having different exposure times, is used as a reference. Also, generation of a pseudo-contour can be restrained and deterioration in image quality can be prevented. Moreover, the proportion of a long-time exposure image in the combined image can be restrained and a combined image with high image quality and with less noise can be provided.

Thus, a recording medium in which the image processing program is recorded and which is readable by a computer can provide an image processing program that enables restraining noise in a dark part of the combined image by properly weighting each of plural images, maintenance of linearity of luminance, prevention of generation of a pseudo-contour, and generation of a high-quality image.

### BRIEF DESCRIPTION OF THE DRAWINGS

The invention will be described with reference to the accompanying drawings, wherein like numbers reference like elements.

FIG. 1 is a view for explaining the configuration of an image processing apparatus according to a first embodiment of the invention.

FIG. 2A to FIG. 2C are view for explaining procedures of weighting image data A, B and C according to the first embodiment of the invention.

FIG. 3 is a view showing an exemplary 1DULT used to correct a group of straight lines shown in FIG. 2B.

FIG. 4 is a view showing an exemplary 1DULT used to decide weight by a weighting calculating unit shown in FIG. 1.

FIG. 5A and FIG. 5B are views showing an exemplary characteristic of combined image data provided as a result of HDR combination according the first embodiment of the invention.

FIG. 6A and FIG. 6B are flowcharts for explaining an image processing method executed in the image processing apparatus according to the first embodiment of the invention.

FIG. 7 is a view for explaining the configuration of an image processing apparatus according to a second embodiment of the invention.

FIG. 8A to FIG. 8D are views showing reference tables for deciding weight according to the second embodiment of the invention.

FIG. 9A to FIG. 9C are view for explaining the advantages of the first and second embodiments, compared to a traditional technique.

FIG. 10A to FIG. 10D are view for explaining a traditional technique.

### DESCRIPTION OF EXEMPLARY EMBODIMENTS

### First Embodiment

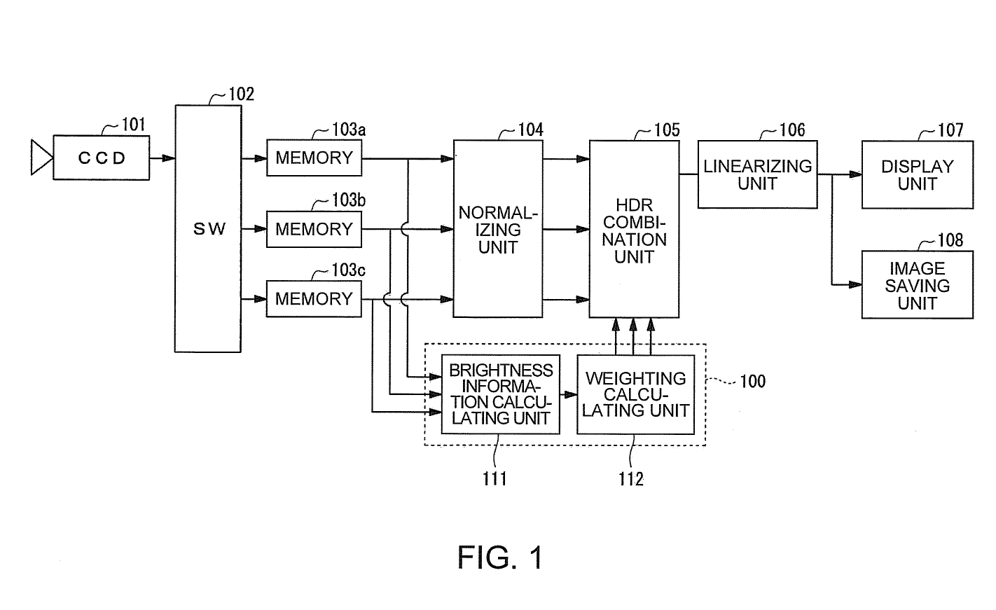

FIG. 1 is a view for explaining the configuration of an image processing apparatus according to a first embodiment of the invention. The image processing apparatus shown in FIG. 1 has a CCD camera 101, a switch (SW) 102 that allocates data (image data) shot by the CCD camera 101 to plural memories 103a, 103b and 103c, a normalizing unit 104 that normalizes the image data allocated to and accumulated in the memories 103a to 103c and thus equalizes their brightness, an HDR combination unit 105 that performs HDR combination of the normalized image data, a linearizing unit 106 that linearizes the combined image data with respect to the luminance of a subject and thus secures linearity of its characteristic, a display unit 107 such as a display screen that displays the combined image data, and an image saving unit 108 that saves the image data.

Such an image processing apparatus is an image processing apparatus that combines plural image data having different quantities of exposure and thus generates a combined image. In this embodiment, image data refers to digital data acquired as a result of picking up an image. Image data represents an image with plural pixels. Pixels contain information about the position (coordinates) and luminance in the image, and R, G and B color components.

In the first embodiment, the CCD camera 101 generates plural image data having difference quantities of exposure in one shot. The generation of image data having different quantities of exposure can be realized, for example, by changing the reading timing of electric charges accumulated in the CCD with an electronic shutter function in the CCD camera 101.

For example, in the case of changing the reading timing in three stages, image data read out from the CCD at in the earliest timing is assumed to be image data A having the smallest quantity of exposure. Then, image data read out from the CCD in the next timing is assumed to be image data B of ordinary exposure. Finally, image data read out from the CCD in the last timing is assumed to be image data C having the large quantity of exposure. In such a configuration, the exposure time is changed to change the quantity of exposure. In the first embodiment, if the exposure time that provides the image data A is Ta, the exposure time that provides the image data B is Tb and the exposure time that provides the image data C is Tc, the ratio of Ta, Tb and Tc is defined as follows.
Ta:Tb:Tc=15:100:500

The memory 103a is used to accumulate the image data A. The memory 103b is used to accumulate the image data B. The memory 103c is used to accumulate the image data C. It should be noted that the first embodiment is not limited the configuration in which the quantity of exposure is changed by the exposure time, and may also be applied to a configuration in which the CCD camera 101 picks up an image plural times with varied apertures, thereby generating plural image data having different quantities of exposure.

The image processing apparatus according to the first embodiment combines plural image data to generate a combined image, as described above. The image processing apparatus according to the first embodiment has a weighting unit 100 that adds weight to adjust the combination proportion of image data to be combined, to the image data A, B and C accumulated in the memories 103a, 103b and 103c. The weighting unit 100 has a brightness information calculating unit 111 that combines data related to luminance of the image data A, B and C and thus generates combined luminance data, and a weighting calculating unit 112 that decides weight to be added to the image data in accordance with the combined luminance data generated by the brightness information calculating unit 111.

In the first embodiment, the brightness information calculating unit 111 functions as a luminance data generating unit, and the weighting calculating unit 112 functions as a weight deciding unit. Also, the normalizing unit 104 functions as a normalizing unit and the linearizing unit 106 functions as a linearizing unit.

In the first embodiment 1, all the image data A, B and C are weighted. However, the invention is not limited to this configuration. It is also possible to weight at least one of the image data A, B and C.

The CCD camera 101 shoots a subject. As shooting is done, electric charges are accumulated in the CCD of the CCD camera 101 and read out in different timing. The electric charges that are read out are inputted to an A/D converter unit via an AFE (analog front end), not shown, and converted into digital data (image data A, B and C). The SW 102 allocates and accumulates the image data A into the memory 103a, the image data B into the memory 103b, and the image data C into the memory 103c.

The accumulated image data A, B and C are subject to processing such as normalization and HDR combination and are then linearized to become combined image data. The image data A, B and C before being normalized are also inputted to the weighting unit 100. The weighting unit 100 calculates weight to be used for image combination in the HDR combination unit 105 and provides the calculated weight to the HDR combination unit 105.

The HDR combination unit 105 combines the image data A, B and C while adding the calculated weight to the normalized image data, and thus generates a combined image. The linearizing unit 106 secures linearity of the combined image and outputs the combined image to the display unit 107 or the image saving unit 108.

Hereinafter, the operation in the above configuration will be described further in detail.

### Weighting

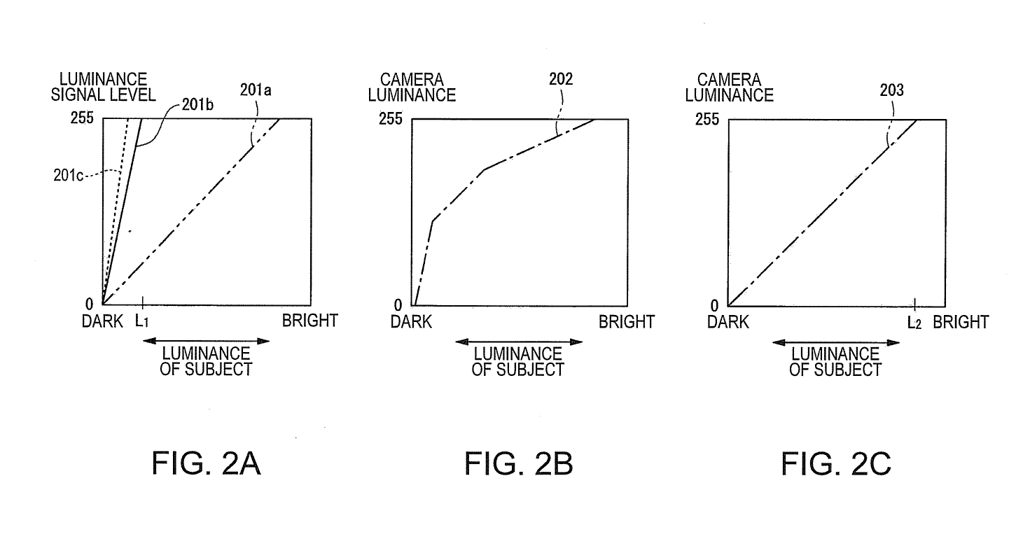

FIG. 2A to FIG. 2C are views for explaining procedures of weighting the image data A, B and C. In each of these views, the vertical axis represents luminance signal level ranging from 0 to 255, and the horizontal axis represents brightness (luminance) of a subject. The luminance of subject on the horizontal axis is the luminance [cd/m²] of a subject shot by the CCD camera 101. The vertical axis the luminance signal level of 0 to 255 of an image acquired by shooting a subject. As is clear from the views, even though the luminance of the subject is the same, the luminance signal level at which the luminance is expressed on the image is different among the image data A, B and C having different exposure times.

FIG. 2A shows straight lines 201a, 201b and 201c that express the relation between the luminance signal level of each of the shot image data A, B and C and the luminance of the subject. The line 201a shows the characteristic of luminance of the image data A. The line 201b shows the characteristic of luminance of the image data B. The line 201c shows the characteristic of luminance of the image data C. The lines 201a, 201b and 201c are equivalent to data related to luminance of the image data A, B and C, respectively.

It can be seen from FIG. 2A that the image data A having a short exposure time can deal with a subject having high luminance since whiteout is less likely to occur in the image data A. It can also be seen that the image data C having a long exposure time can deal with a subject having low luminance since blackening is less likely to occur in the image data C. Therefore, by HDR combination in which the three image data A, B and C are combined in accordance with brightness of the image, it is possible to generate a high-quality image with less blackening and whiteout in accordance with an image having broad range of luminance.

FIG. 2B shows a broken line 202 formed by combining the luminance signal levels of the straight lines 201a, 201b and 201c shown in FIG. 2A. Such a broken line 202 shows combined luminance data acquired by combining data related to luminance of the image data A, B and C. The combination is carried out by adding up the luminance signal levels of the lines 201a, 201b and 201c and then dividing the result to acquire an average value. The group of straight lines 202 generated in this manner represents the combined luminance data of the first embodiment. Its luminance signal level is hereinafter called camera luminance. Also in the group of straight lines 202, if the luminance signal levels of all the image data A, B and C are saturated, the camera luminance is clipped in the saturated area.

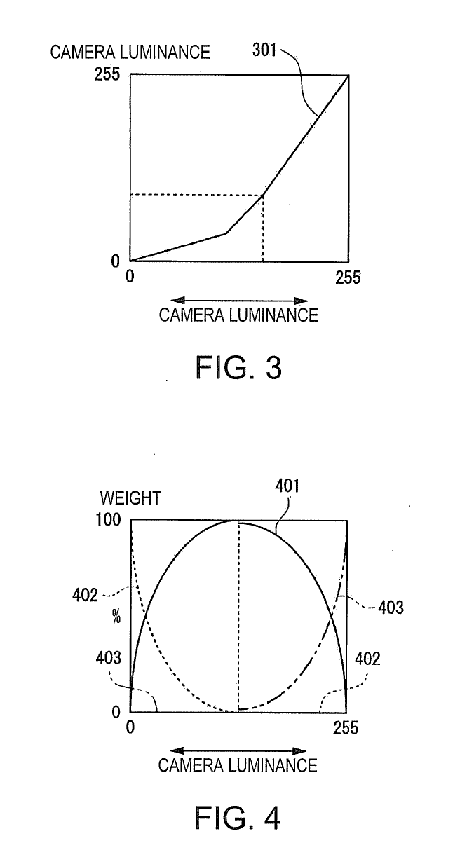

Although the combined luminance data has continuity, the saturation values of the lines 201a, 201b and 201c are added up and therefore the slope changes (FIG. 2B). In the first embodiment, to eliminate the change in the slope, the group of straight lines 202 is corrected to a straight line 203 having a constant slope by using a reference table (1DULT (1D lookup table) or a function. FIG. 2C shows the straight line 203 having a constant slope after conversion. FIG. 3 is a view showing an exemplary 1DLUT used to correct the group of straight lines 202. In the first embodiment 1, it is assumed that the 1DULT or function is prepared in advance in the image processing apparatus.

As described above, in the case where the characteristic of the image data B of ordinary exposure (line 201b) is used for weighting as in the traditional technique, the luminance of subject is at a constant luminance signal level in a range greater than L1 shown in FIG. 2A. On the other hand, the combined luminance data is generated by combining the images data A, B and C, and therefore the camera luminance does not become constant in a broader luminance range than image data of ordinary exposure. Thus, in the first embodiment, the luminance signal level can be properly set in a broader luminance range than in the traditional technique and image combination can be carried out with reference to an image having less blackening or whiteout.

The weighting calculating unit 112 decides weight in accordance with the combined luminance data generated as described above, and adds the weight to the image data A, B and C. The weight is decided by using the function or 1DULT that associates image data and weight in accordance with camera luminance.

FIG. 4 is a view showing an exemplary 1DULT used to decide weight by the weighting calculating unit 112. The vertical axis in FIG. 4 represents weight to be added to each of the image data A, B and C. The horizontal axis represents camera luminance of the combined luminance data. A curve 401 shown in FIG. 4 shows the weight of the image data B. A curve 402 shows the weight of the image data C. A curve 403 shows the weight of the image data A.

If the image data are weighted in accordance with FIG. 4, the image data C acquired by using a long exposure time is relatively largely weighted in a part of low luminance of the subject, that is, in a part of low luminance of the combined image. Therefore, the proportion of the image data increases in the part of low luminance of the combined image. As the luminance of the combined image rises, the proportion of the image data B increases. As the luminance exceeds an intermediate value, the proportion of the image data A having a short exposure time in the combined image increases.

The weight is decided for each pixel of the image data A, B and C. For example, the weight W_Ta added to a pixel situated at coordinates (x,y) of the image data A having the exposure time Ta is expressed as W_Ta(x,y). Similarly, the weight W_Tb added to a pixel situated at coordinates (x,y) of the image data B having the exposure time Tb is expressed as W_Tb(x,y). The weight W_Tc added to a pixel situated at coordinates (x,y) of the image data C having the exposure time Tc is expressed as W_Tc(x,y).

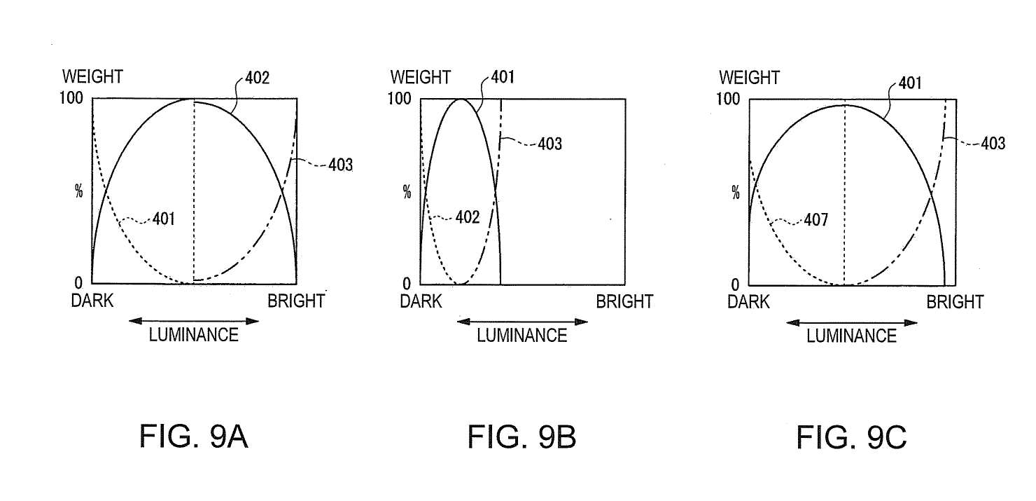

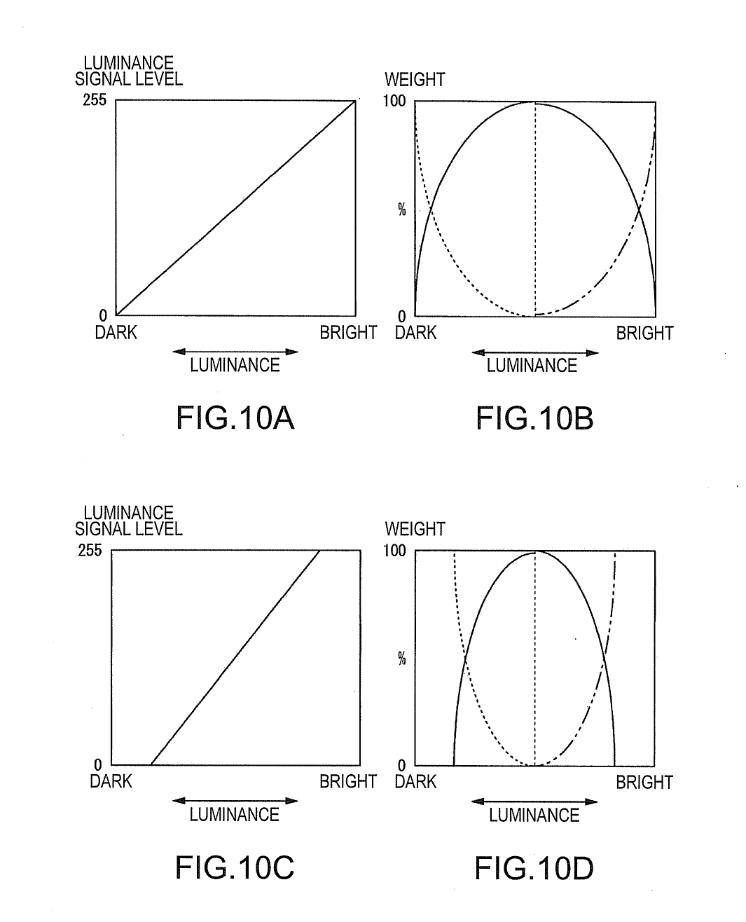

In FIG. 9C, the camera luminance on the horizontal axis in FIG. 4 is converted to luminance of subject. In the first embodiment, the range where weighting is possible on the horizontal axis in FIG. 9C can be used as a broader range of luminance of subject than in FIG. 9B showing the weighting in the traditional technique, as described above. In the first embodiment as described above, it is possible to handle an image having a greater dynamic range than in the traditional technique which uses image data of ordinary exposure as a reference.

### HDR Combination

Next, processing of the image data A, B and C sent from the memories 103a, 103b and 103c to the HDR combination unit 105 via the normalizing unit 104 will be described.

The normalizing unit 104 normalizes the image data A, B and C having different exposure times so as to equalize their brightness. The normalization is carried out as expressed by the following equations (1), (2) and (3). In these equations, the image data A before normalization is expressed as IMG_Ta, the image data A after normalization as IMG_Ta_N, the image data B before normalization as IMG_Tb, the image data B after normalization as IMG_Tb_N, the image data C before normalization as IMG_Tc, and the image data C after normalization as IMG_Tc_N.

IMG_{—}Ta_{—}N=IMG_{—}Ta×Tc/Ta (1)

IMG_{—}Tb_{—}N=IMG_{—}Tb×Tc/Tb (2)

IMG_Tc_N=IMG_Tc (3)

The HDR combination unit 105 adds weight to pixels situated at the same coordinates, of the image data A, B and C, and combines these pixels. The value HDR(x,y) of a pixel situated at coordinates (x,y) of the combined image is found by the following equation (4).

$$\begin{matrix}HDR ( x , y ) = W\_Ta ( x , y ) \times IMG\_Ta \_N + \\ W\_Tb ( x , y ) \times IMG\_Tb \_N + \\ W\_Tc ( x , y ) \times IMG\_Tc \_N\end{matrix} \qquad ( 4 )$$

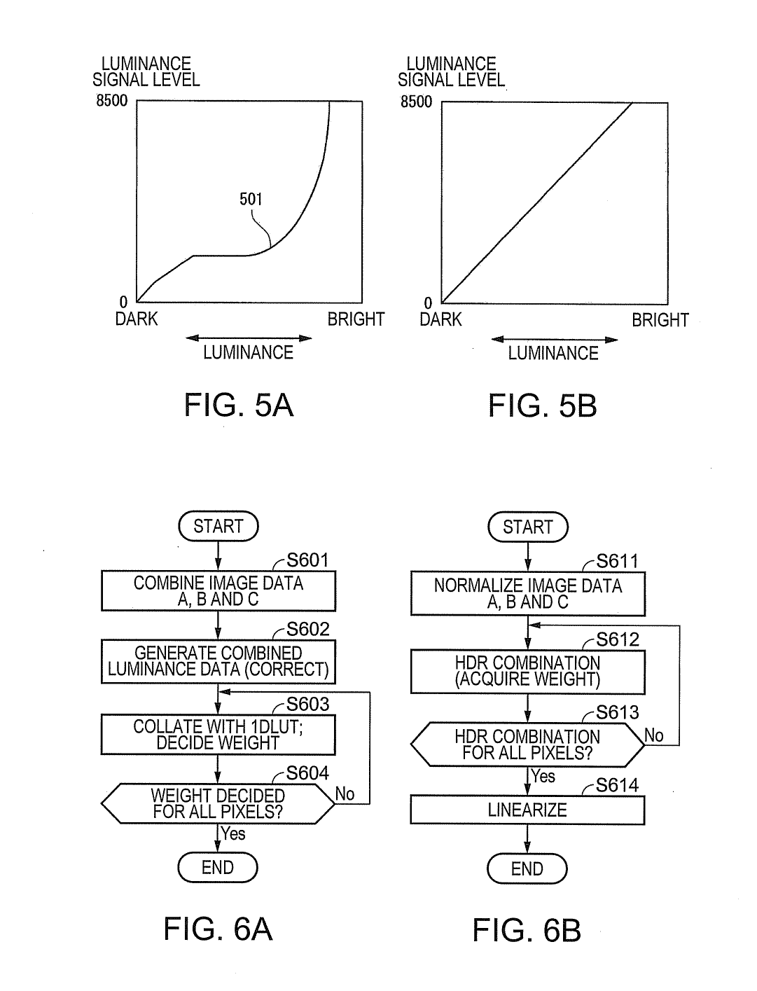

FIG. 5A and FIG. 5B are views showing exemplary characteristics of the combined image data as a result of HDR combination as described above. The vertical axis in FIG. 5A and FIG. 5B represents the luminance signal level of the combined image formed by combining the normalized image data A, B and C. The horizontal axis represents luminance of the subject. The luminance signal level value of 8500 shown on the vertical axis in FIG. 5A and FIG. 5B is 255×Tc/Ta, that is, the maximum value of IMG_Ta_N, and is also the maximum value of the luminance signal level of the HDR luminance-combined image.

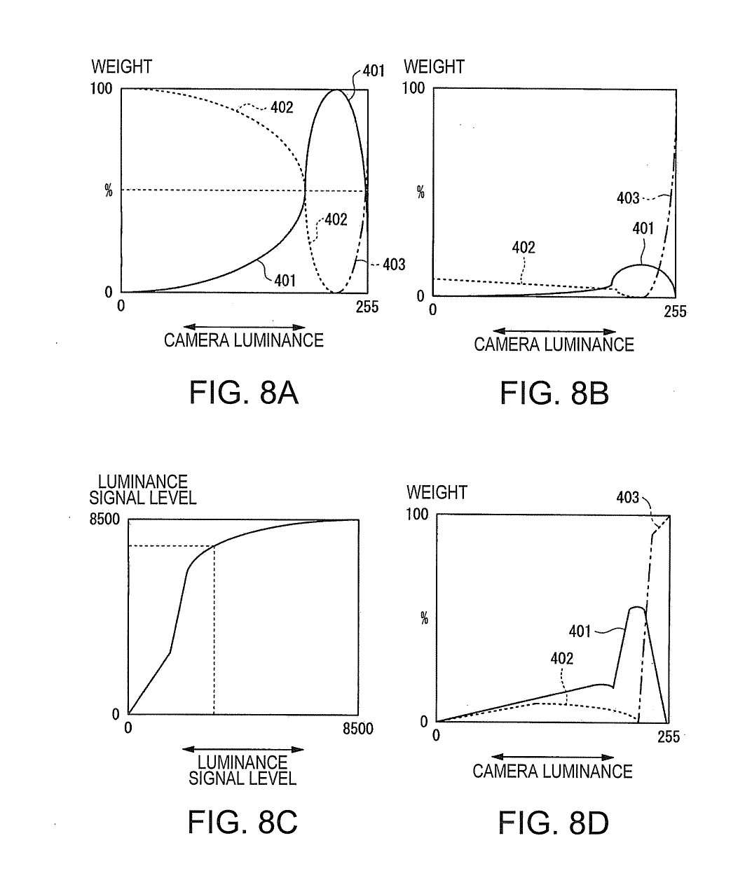

In the case where the characteristic of the combined image expressed as shown in FIG. 5A, the gradation of the image does not uniformly change, which lowers the quality of the image. The linearizing unit 106 corrects the characteristic expressed by a curve 501 in FIG. 5A and linearizes the characteristic as shown in FIG. 5B so that the luminance signal level of the image linearly changes in accordance with the luminance. The correction can be carried out by using a preset function or 1DLUT or can be carried out by using a function or 1DLUT acquired as a result inverse conversion of the characteristic of FIG. 5A. FIG. 8C is a view showing an exemplary 1DLUT used to correct the curve 501.

FIG. 6A and FIG. 6B are flowcharts for explaining an image processing method executed in the image processing apparatus according to the above-described first embodiment. FIG. 6A is a flowchart for explaining processing to decide weight by using the combined luminance data provided by combining the image data A, B and C. FIG. 6B is a flowchart for explaining processing of adding the decided weight to the image data and performing HDR combination.

The image data A, B and C generated by the CCD camera 101 are accumulated in the memories 103a, 103b and 103c, respectively. The accumulated image data A, B and C are sent to the normalizing unit 104 for HDR combination and inputted to the weighting unit 100.

In the weighting unit 100, the brightness information calculating unit 111 combines the image data A, B and C are (step S601), as shown in FIG. 6A. The brightness information calculating unit 111 also allocates camera luminance with respect to the luminance signal level of 0 to 255 acquired by combining the image data A, B and C and thus generates combined luminance data (step S602). In the first embodiment, the data is corrected into a straight line at the time of generating camera luminance.

Next, the weighting calculating unit 112 decides weight to be added to each of the image data A, B and C in accordance with the camera luminance acquired by combining the image data A, B and C. The decision of weight is carried out with reference to the LUT shown in FIG. 4.

The weighting calculating unit 112 determines whether pixel weighting is decided with respect to all the coordinates of the image data A, B and C (step S603). If there is a pixel that has not been weighted yet (No in step S603), the processing to decide weight is continued. On the other hand, when weighting is decided for the pixels situated at all the coordinates, the processing ends.

The normalizing unit 104 normalizes the image data A, B and C (step S611), as shown in the flowchart of FIG. 6B. The normalization is carried out to equalize the difference in brightness due to the difference in exposure time of the image data A, B and C.

Next, the HDR combination unit 105 receives the weight decided in accordance with the flowchart shown in FIG. 6A and performs HDR combination to generate combined image data (step S612). Then, it is determined whether combination is done with respect to all the pixels of the combined image (step S613). If combination is not done for all the pixels (No in step S613), HDR combination is continued. On the other hand, if combination is done for all the pixels (Yes in step S613), the linearizing unit 106 linearizes the combined image (step S614) and the processing ends.

In the above-described flowchart, steps S601 and S602 in FIG. 6A form a luminance data generation step of the first embodiment. Steps S603 and S604 form a weight decision step of the first embodiment.

The above-described image processing method according to the first embodiment is carried out by an image processing program according to the first embodiment, which is executed by a computer. The image processing program according to the first embodiment is provided in the form of being recorded in a recording medium readable by a computer such as a CD-ROM, floppy (trademark registered) disk (FD) or DVD as a file having a format that can be installed or executed. The image processing program according to the first embodiment may also be stored on a computer connected to a network such as the Internet and downloaded via the network.

Moreover, the image processing program according to the first embodiment may be provided in the form of being recorded in a memory device such as a computer-readable ROM, flash memory, memory card, or USB-connection flash memory.

According to the above-described first embodiment, weight of image data can be decided in accordance with combined luminance data formed as a result of combining data related to luminance of plural image data acquired by shooting with different quantities of exposure. The combined luminance data has a broader luminance range with linear luminance signal level than the luminance of an image of an ordinary exposure time. Therefore, proper weighting can be carried out in a broader luminance range than in the case of using an image shot with an ordinary exposure time, of images having different exposure times, as a reference. Also, generation of a pseudo-contour can be restrained and the image quality can be prevented from lowering. Moreover, the proportion of a short-time exposure image in the combined image can be restrained and a combined image with high image quality and with less noise can be provided.

### Second Embodiment

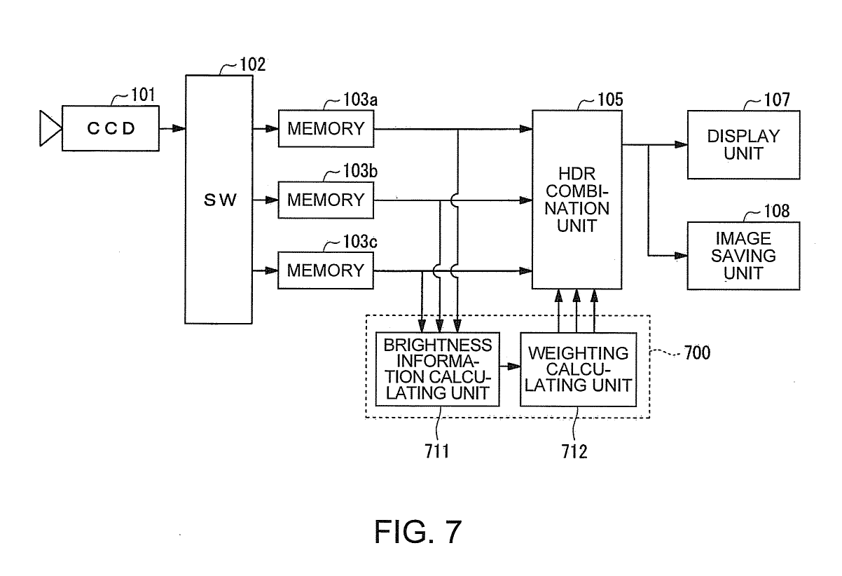

Next, a second embodiment of the invention will be described. In the second embodiment, the normalizing unit 104 of the image processing apparatus according to the first embodiment is omitted and the functional configuration and processing steps are simplified. For simplification, in the second embodiment, the normalizing unit 104 and the linearizing unit 106 are omitted, and the image data A, B and C are normalized or normalized by using the 1DLUT or function used for weighting. In such second embodiment, a weighting unit 700 (FIG. 7) also functions as the normalizing unit and the linearizing unit.

FIG. 7 is a view for explaining the configuration of the image processing apparatus according to the second embodiment. In FIG. 7, similar parts of the configuration to those described in the first embodiment are denoted by the same reference numerals and their description will be partly omitted. The image processing apparatus according to the second embodiment, as in the first embodiment, has a CCD camera 101, a SW 102, memories 103a, 103b and 103c, an HDR combination unit 105, a weighting unit 700 including a brightness information calculating unit 711 and a weighting calculating unit 712, a display unit 107, and an image saving unit 108.

However, the image processing apparatus according to the second embodiment differs from the first embodiment in not having the normalizing unit 104 and the linearizing unit 106. The image data are inputted to the HDR combination unit 105 without being normalized. The HDR-combined image is outputted to the display unit 107 and the image saving unit 108 without being particularly linearized.

The image data A, B and C provided by the CCD camera 101 are saved in the memories 103a, 103b and 103c, respectively. Then, the image data A, B and C are combined at the brightness information calculating unit 711. As a result of the combination, combined luminance data is produced. However, the brightness information calculating unit 711 does not make correction to linear the combined image data and uses the group of straight lines 202 shown in FIG. 2B as the camera luminance of the combined luminance data. The weighting calculating unit 712 decides weight in accordance with the group of straight lines 202. The decided weight is inputted to the HDR combination unit 105.

In this case, the weighting calculating unit 712 decides weight by using the 1DLUT shown in FIG. 8D since it decides weight in accordance with the non-linear combined luminance data. The 1DLUTs shown in FIG. 8A, FIG. 8B and FIG. 8C are 1DLUTs in the process of generating the 1DLUT of FIG. 8D. In each of these views, the vertical axis represents weight to be added to the image data A, B and C, and the horizontal axis represents camera luminance of 0 to 255.

Here, the process of generating the 1DLUT of FIG. 8D will be described. In the second embodiment, since the luminance signal level of the HDR-combined image data A, B and C is not linear with respect to the luminance of the actual image, it is necessary to decide weighting of the image data by using the 1DLUT shown in FIG. 8A. This 1DLUT is the 1DLUT shown in FIG. 4 that takes into consideration the correction of the group of straight lines 202 in the 1DLUT shown in FIG. 3.

In the second embodiment, since the image data are not normalized, it is necessary to multiply the characteristic shown in the LUT of FIG. 8A by coefficients T3/T1, T2/T1 and T3/T3 in consideration of normalization. FIG. 8B shows the 1DLUT provided as a result of the multiplication.

Moreover, in the second embodiment, the weighting calculating unit 712 must decide weight by using the 1DLUT prepared also in consideration of linearization of the combined image provided after combination. FIG. 8C shows the 1DLUT for linearizing the combined image. FIG. 8D shows the 1DLUT as a result of combining the 1DLUT shown in FIG. 8B with the 1DLUT shown in FIG. 8C.

The 1DLUT shown in FIG. 8D, prepared by the above-described processing, functions in the weighting calculating unit 712 as a 1DLUT for weight decision in consideration of linearization of the combined luminance data, normalization of the image data A, B and C, and linearization after HDR combination.

Here, the advantages of the first and second embodiments of the invention will be summarized. That is, the first and second embodiments of the invention focus on the fact that key information in adjusting weight at the time of combining images is the brightness of the subject. Therefore, for an image acquired by shooting a bright part of the subject, an image with a short exposure time is mainly used and combined with an image with a shorter exposure time. Thus, an image having a good S/N ratio can be provided.

As a standard to determine the brightness (luminance) of the subject, an ordinary exposure image (the line 201b in FIG. 2A) is traditionally used, but blackening and whiteout occur also in the ordinary exposure image. Therefore, image information at the luminance where blackening or whiteout occurs is missing, causing inconvenience that proper weighting cannot be carried out in this luminance range.

Meanwhile, in the first and second embodiments, plural image data having different exposure times are combined to prepare combined luminance data, which is used as a reference for weighting. Since the combined luminance data has a smaller range where the luminance signal level is saturated than the ordinary exposure image, proper weight can be decided even in a higher luminance range.

Next, the relation between an image to be a reference for weighting and the image quality will be described. FIG. 9A to FIG. 9C are views for explaining the advantages of the first and second embodiments, compared with the traditional technique. FIG. 9A shows a 1DLUT for ideal weighting. However, in the case where weighting is carried out by using an ordinary exposure image as a reference in which the luminance signal level causes whiteout, many of the images are determined as bright images. Therefore, the weight reaches a constant value in a relatively early stage and a combined image having a large proportion of short-time exposure is generated as shown in FIG. 9B.

A short-time exposure image generally has a lot of noise. When the proportion of the short-time exposure image in the combined image increases, the noise (granularity) of the combined image increases and it may deteriorate the image quality.

If images are weighted in accordance with combined luminance data acquired by combining image data having different exposure times, as in the first and second embodiments of the invention, ideal weighting shown in FIG. 9A can be realized, as shown in FIG. 9C.

The entire disclosure of Japanese Patent Application No. 2007-211655 filed on Aug. 15, 2007 is expressly incorporated by reference herein.

What is claimed is:

1. An image processing apparatus that generates a combined image by combining plural image data acquired as a result of digitizing plural images acquired by shooting with different quantities of exposure, the apparatus comprising:
a weighting unit that adds weight to adjust proportion of combination of the image data, to at least one of the plural image data;
wherein the weighting unit includes
a luminance data generating unit that combines data related to luminance of the plural image data and thus generates combined luminance data, and
a weight deciding unit that decides the weight added to the image data in accordance with the combined luminance data generated by the luminance data generating unit.

2. The image processing apparatus according to claim 1, further comprising a normalizing unit that normalizes the plural image data and equalizes brightness of each image data.

3. The image processing apparatus according to claim 2, further comprising a linearizing unit that linearizes the combined image data, which is image data acquired as a result of adding the weight decided by the weight deciding unit to the plural image data and then combining the plural image data, with respect to the luminance of a subject.

4. The image processing apparatus according to claim 2, wherein the weight deciding unit decides weight by using a reference table or a function that associates image data and weight in accordance with luminance, and the normalizing unit normalizes the plural image data by using the reference table or the function.

5. The image processing apparatus according to claim 3, wherein the weight deciding unit decides weight by using a reference table or a function that associates image data and weight in accordance with luminance, and the linearizing unit linearizes the combined image data by using the reference table or the function.

6. An image processing method for generating a combined image by combining plural image data acquired as a result of digitizing plural images acquired by shooting with different quantities of exposure, the method comprising:
adding weight to adjust proportion of combination of the image data, to at least one of the plural image data;
wherein the weighting includes
combining data related to luminance of the plural image data and thus generating combined luminance data, and
deciding the weight added to the image data in accordance with the generated combined luminance data.
